(19) United States
(12) Patent Application Publication
(10) Pub. No.: US 2026/0105191 A1
(43) Pub. Date: Apr. 16, 2026

(54) SYSTEMS AND METHODS FOR GENERATING COMPOSITE DATA FOR PROTECTION OF REAL DATA

(71) Applicant: BANK OF AMERICA CORPORATION, CHARLOTTE, NC (US)

(72) Inventors: Manu Jacob Kurian, Dallas, TX (US); Aeric John Solow, Allen, TX (US)

(73) Assignee: BANK OF AMERICA CORPORATION, CHARLOTTE, NC (US)

(21) Appl. No.: 18/916,200

(22) Filed: Oct. 15, 2024

(51) Int. Cl. G06F 21/62

(52) U.S. Cl. CPC G06F 21/6254

(57) ABSTRACT

Systems, computer program products, and methods are described herein for generating composite data. An example system may receive user data, wherein the user data comprises user attributes. The system may use a generative AI subsystem to analyze the user data and identify patterns and distributions characterizing the user attributes. The generative AI subsystem may generate synthetic attributes based on this analysis and use these attributes to create composite data. The system may also employ a variable obfuscation subsystem to determine a required level of obfuscation for the composite data based on an analysis of trust factors associated with a receiving entity. The variable obfuscation subsystem may determine a data transparency parameter (DTP) for the synthetic attributes and/or the composite data based on at least the required level of obfuscation. The variable obfuscation subsystem may then trigger the generative AI subsystem to generate the composite data in accordance with the DTP.

### TECHNOLOGICAL FIELD

Example embodiments of the present disclosure relate to data privacy and information security. More specifically, embodiments of the invention pertain to systems and methods for anonymizing user data when it is shared with third parties.

### BACKGROUND

With the rise in data sharing between entities (e.g., vendors, sister companies), maintaining the privacy and anonymity of users has become a critical concern. Even when personal identifying information is removed, entities receiving the data may still use other attributes or patterns within the data to re-identify users, leading to potential data breaches. Such breaches may expose users'private information or provide insights into their activities across different accounts, compromising their security and privacy.

Applicant has identified a number of deficiencies and problems associated with mitigating exposures associated with re-identification of users and unauthorized access to sensitive information. Many of these identified problems have been solved by developing solutions that are included in embodiments of the present disclosure, many examples of which are described in detail herein.

### BRIEF SUMMARY

Systems, methods, and computer program products are provided for mitigating exposures associated with re-identification of users and unauthorized access to sensitive information.

In one aspect, a system for generating composite data is presented. The system comprising: a generative Artificial Intelligence (AI) subsystem, configured to: receive user data, wherein the user data comprises user attributes; analyze the user data to identify patterns and distributions characterizing the user attributes; generate synthetic attributes for the user data based on analyzing the user data; and generate composite data using the synthetic attributes, wherein the composite data retains characteristics of the user data without identifying any particular user record in the user data; a variable obfuscation subsystem operatively coupled to the generative AI subsystem, configured to: determine a required level of obfuscation for the composite data based on an analysis of trust factors associated with a receiving entity; determine a data transparency parameter (DTP) for the synthetic attributes and/or the composite data based on at least the required level of obfuscation; and trigger the generative AI subsystem to generate the composite data using the DTP.

In some embodiments, the user attributes comprise at least one of user group data, behavioral data, or transactional data.

In some embodiments, the generative AI subsystem is further configured to: generate the synthetic attributes for the user data that mirror the identified patterns and distributions.

In some embodiments, the generative AI subsystem is further configured to: dynamically update the synthetic attributes as new user data is received, such that the generated composite data reflects the most recent patterns and distributions in the user data.

In some embodiments, the trust factors associated with the receiving entity comprises at least one of a historical data handling practice, security certifications and compliance history, duration and nature of business relationship with the receiving entity, data sensitivity assessment, internal security infrastructure, third-party assessments, organizational maturity and information technology (IT) capability, data usage policies and agreements, geographical jurisdiction, or reputation and market standing.

In some embodiments, the DTP ranges between a fully transparent level and a fully opaque level, allowing for fine-tuning of user record detail embedded in the composite data.

In some embodiments, the generative AI subsystem, when triggered with a low DTP value by the variable obfuscation subsystem, generates composite data that retains more detailed information for analysis while anonymizing specific user records.

In some embodiments, the generative AI subsystem, when triggered with an intermediate DTP value, generalizes the synthetic attributes such that specific user information, such as precise life stages or locations, is transformed into broader categories or ranges.

In some embodiments, the generative AI subsystem, when triggered with a high DTP value, generates highly aggregated and generalized composite data, retaining only broad statistical insights to minimize exposure of re-identification of individual user records.

In some embodiments, the variable obfuscation subsystem is further configured to: dynamically adjust the DTP in real-time based on updates in the receiving entity's trust status or changes in sensitivity of the user data.

In another aspect, a computer program product for generating composite data is presented. The computer program product comprising a non-transitory computer-readable medium comprising code configured to cause an apparatus to: receive user data, wherein the user data comprises user attributes; analyze the user data to identify patterns and distributions characterizing the user attributes; generate synthetic attributes for the user data based on analyzing the user data; generating composite data using the synthetic attributes, wherein the composite data retains characteristics of the user data without identifying any particular user record in the user data; determine a required level of obfuscation for the composite data based on an analysis of trust factors associated with a receiving entity; determine a data transparency parameter (DTP) for the synthetic attributes and/or the composite data based on at least the required level of obfuscation; and trigger the generative AI module to generate the composite data using the DTP.

In yet another aspect, a method for generating composite data is presented. The method comprising: receiving, using a generative AI subsystem, user data, wherein the user data comprises user attributes; analyzing, using a generative AI subsystem, the user data to identify patterns and distributions characterizing the user attributes; generating, using the generative AI subsystem, synthetic attributes for the user data based on analyzing the user data; generating, using the generative AI subsystem, composite data using the synthetic attributes, wherein the composite data retains characteristics of the user data without identifying any particular user record in the user data; determining, using a variable obfuscation subsystem, a required level of obfuscation for the composite data based on an analysis of trust factors associated with a receiving entity; determining, using the variable obfuscation subsystem, a data transparency parameter (DTP) for the synthetic attributes and/or the composite data based on at least the required level of obfuscation; and triggering, using the variable obfuscation subsystem, the generative AI subsystem to generate the composite data using the DTP.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for generating composite data, in accordance with an embodiment of the invention;

FIG. 2 illustrates an exemplary generative AI subsystem 200, in accordance with an embodiment of the invention;

FIG. 3 illustrates a process flow for generating composite data, in accordance with an embodiment of the invention; and

FIG. 4 illustrates a process flow for generating composite data based on a data transparency parameter, in accordance with an embodiment of the invention.

### DETAILED DESCRIPTION

### Overview

Traditional methods of anonymizing data often fail to adequately protect user identities, as they may not account for various ways that entities could use secondary characteristics or patterns in the data to re-identify individuals. Furthermore, existing methods may involve numerous steps or require significant manual input, thereby increasing computing resources and operational overhead. The need for a more efficient, automated, and reliable system that ensures the anonymization of user data, while still allowing insights from the data to be preserved, is therefore essential.

Embodiments of the invention provide a system that generates pseudo characteristics to conceal user identities without compromising the core utility of the shared data. The system may create composite data that aggregates and blends characteristics of multiple users, ensuring that no individualized data can be easily extracted or identified. Specifically, the system may employ generative AI to generate pseudo characteristics for user data. The generative AI models can be trained on user data to learn the patterns and distributions that exist across various user group, behavioral, or transactional characteristics. Once trained, the generative AI models can generate new synthetic attributes (pseudo characteristics) that closely resemble the original data patterns but are not directly tied to any specific individual. For example, if a dataset contains information about users within a certain life stage range (e.g., 20-30), generative AI models can create synthetic life stage-related attributes that match the overall distribution of the group, while obfuscating the precise life stage of any one user. This process preserves the analytical insights needed to understand the group as a whole, but makes it much harder to re-identify any single user through secondary characteristics.

Additionally or alternatively, embodiments of the invention may employ generative AI models to generate composite data—blending the characteristics of multiple users. Rather than simply aggregating data in a straightforward manner, generative AI models can intelligently combine user data to create composite portfolios that retain key attributes needed for analysis (e.g., life stage distribution, geographic location trends, etc.) but obfuscate individual-level details. For instance, a composite portfolio could represent a blend of multiple users' characteristics in such a way that it becomes statistically representative of a subset of the population, while ensuring that no real user's exact data is replicated. This may be achieved by having generative AI model learn from the underlying patterns of multiple users and then generate synthetic data that mixes their attributes, resulting in a composite portfolio that is distinct from any single individual.

Additionally or alternatively, embodiments of the invention can leverage generative AI models to dynamically adjust the transparency or opacity of the composite data provided to recipient entities, based on the trustworthiness or sensitivity level associated with these entities. The system can incorporate a Data Transparency Parameter (DTP), which serves as a configurable control for determining the level of detail or opacity embedded in the composite data shared with a recipient. The DTP functions as an adjustable parameter that can be tuned based on factors such as the recipient's past behavior, their relationship with the data provider, and the sensitivity level of the data being shared. As such, generative AI models may be used to create varying levels of composite portfolios from learned patterns from user data. The DTP may be a scalable variable that ranges from fully transparent to fully opaque, with intermediate levels to finely adjust the degree of detail. For instance, in cases where the recipient entity is deemed highly trustworthy (e.g., a long-standing business partner or an entity with a demonstrated history of secure data handling), the DTP is set to a low value, allowing the system to generate composite data that retains a higher degree of the original information's transparency. This may include more granular user group information, behavioral patterns, or aggregated statistical data that provides detailed insights while still anonymizing individual users. For entities with moderate trust levels or when the nature of the relationship requires more caution, the DTP may be set to an intermediate value. In this configuration, generative AI models create composite portfolios that retain the essential features of the data necessary for analysis but blur or transform more sensitive or unique attributes to prevent potential re-identification. For instance, a user's exact life stage might be replaced with a wider life stage range, or precise location data might be generalized to broader geographical regions. When the recipient entity is less trusted (e.g., a new vendor, a third-party service with limited or unverified security measures), the DTP is set to a high value. Generative AI models then produce highly opaque composite data, obscuring key features and only retaining the most generalized insights from the dataset. In such cases, the data shared may consist of only broad statistical summaries or highly aggregated patterns that significantly reduce the exposure of individual re-identification.

Embodiments of the invention provide several technical improvements that address issues related to data anonymization and the protection of user identities. The system, using generative AI models, operates with a highly efficient architecture that minimizes the number of steps required to achieve a solution, thereby reducing the computing resources necessary for data processing. The system optimizes computing resource usage by automating the generation of pseudo-characteristics and composite data portfolios, which removes the need for manual input, improving both speed and efficiency. This also conserves storage and processing resources, as the system bypasses unnecessary manual processing steps that would otherwise increase computational overhead. For instance, by automatically determining the appropriate level of data opacity through the DTP, the system reduces network traffic and load on existing computing infrastructure. Embodiments of the invention also provide a more accurate solution to the problem of data anonymization by leveraging advanced generative AI models that dynamically adapt to user data patterns. The system's use of the DTP allows for the fine-tuning of data transparency based on the trust level of the recipient, such that the composite data generated is contextually appropriate and less prone to errors that would require further computing resources for correction. This adaptive approach ensures that data opacity is calibrated to the precise level necessary, reducing the exposure of oversharing or inefficient anonymization. Furthermore, the technical solution described herein uses a rigorous, computerized process that performs specific tasks and activities not previously automated, such as real-time analysis and adjustment of data transparency levels according to the recipient's trust level. By utilizing generative AI models, the system can bypass several traditional steps that required manual intervention or basic rule-based systems, further conserving computing resources and reducing the time needed to process data for multiple recipient entities. In specific implementations, the system dynamically adapts the DTP setting without the need for manual configuration, thus bypassing the manual steps previously implemented. This results in reduced computing resources being used for data anonymization, as the system avoids the additional network and processing loads typically associated with manual or static configurations. As a result, the system achieves a more efficient and scalable solution for protecting user anonymity, ensuring both the confidentiality and utility of the shared data.

Embodiments of the present disclosure will now be described more fully hereinafter with reference to the accompanying drawings, in which some, but not all, embodiments of the present disclosure are shown. Indeed, the present disclosure may be embodied in many different forms and should not be construed as limited to the embodiments set forth herein; rather, these embodiments are provided so that this disclosure will satisfy applicable legal requirements. Thus, it should be understood that each block of the block diagrams and flowchart illustrations may be implemented in the form of a computer program product; an entirely hardware embodiment; an entirely firmware embodiment; a combination of hardware, computer program products, and/or firmware; and/or apparatuses, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments may produce specifically-configured machines performing the steps or operations specified in the block diagrams and flowchart illustrations. Accordingly, the block diagrams and flowchart illustrations support various combinations of embodiments for performing the specified instructions, operations, or steps.

Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on. ”Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager stager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, satisfied, etc.

### EXAMPLE SYSTEM ENVIRONMENT

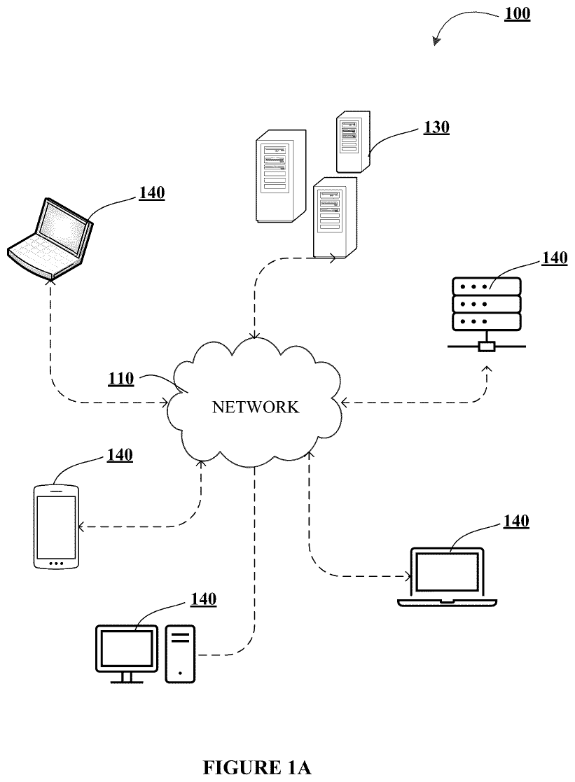

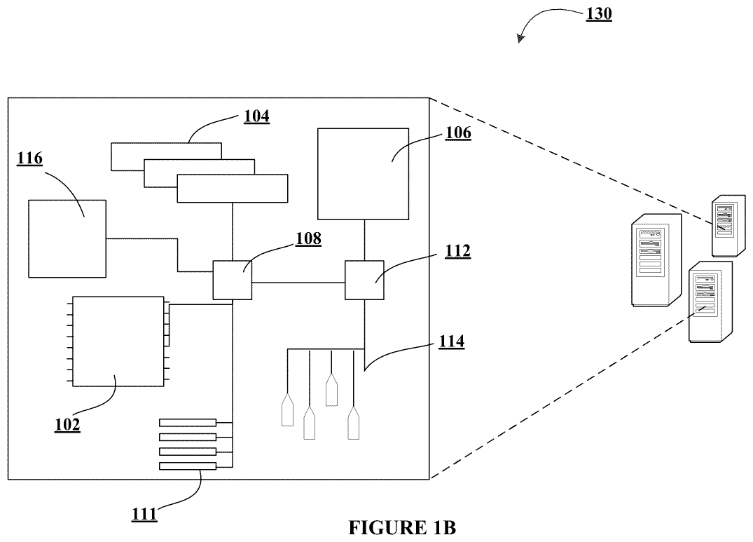

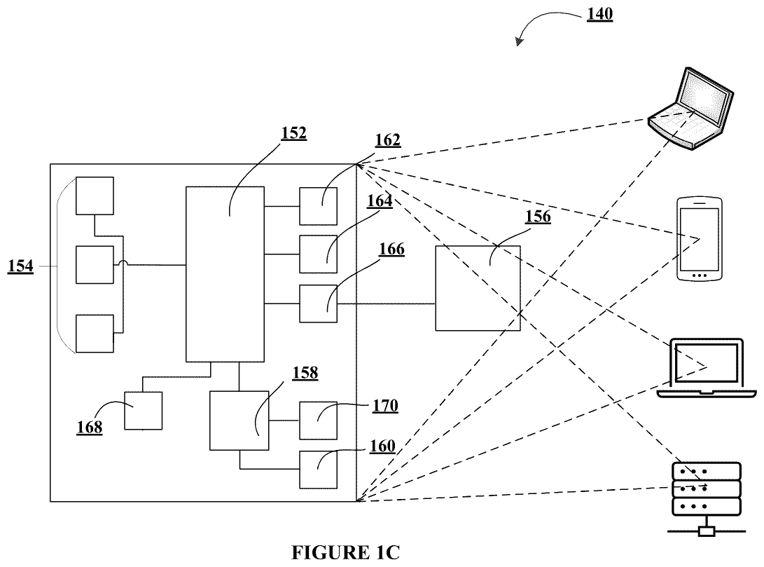

FIGS. 1A-1C illustrate technical components of an exemplary distributed computing environment for generating composite data 100, in accordance with an embodiment of the invention. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file servers, or the like, as well as a range of digital computing devices, including laptops, desktops, video recorders, audio/video players, radios, workstations, and/or the like. Additionally, system 130 may include a variety of auxiliary network devices, encompassing wearable devices, Internet-of-things (IoT) devices, electronic kiosk devices, entertainment consoles, mainframes, and/or the like, in any combination to cater to the complexity and diversity of contemporary digital ecosystems.

The end-point device(s) 140 may encompass an array of electronic devices, such as personal digital assistants, cellular telephones, smartphones, laptops, desktops, and merchant input devices like point-of-sale (POS) systems, electronic payment kiosks, and automated teller machines (ATMs). End-point device(s) 140 may also include edge devices like routers, routing switches, integrated access devices (IAD), and/or the like, and devices capable of interfacing with 5G networks, delivering enhanced data processing and connectivity.

The network 110 may include a distributed network architecture that spans a variety of network types, facilitating a cohesive data communication network that can be managed jointly or individually. The network architecture supports shared communication as well as distributed processing across platforms such as telecommunication networks, local area networks (LAN), wide area networks (WAN), global area networks (GAN), the Internet infrastructure, and/or the like. Network 110 may also integrate emerging networking technologies, including software-defined networking (SDN), network function virtualization (NFV), and next-generation wireless communication standards like 5G. Network 110 may employ secure or unsecure, as well as wireless, wired, and optical interconnection technologies, and/or the like, to accommodate a spectrum of communication and processing needs.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the invention. As shown in FIG. 1B, the system 130 may include a processor 102, memory 104, input/output (I/O) device 116, and a storage device 110. The system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The generative AI subsystem may be configured to process user data and generate composite data based on synthetic attributes derived from the user data. In this regard, the generative AI subsystem may receive user data, which comprises various user attributes, such as user group, behavioral, or transactional information. Upon receiving the data, the generative AI subsystem may analyze the user data to identify patterns and distributions that characterize the user attributes. Using these identified patterns, the generative AI subsystem may generate synthetic attributes that closely mimic the underlying data trends without directly replicating any individual user's information. The generative AI subsystem may then use the synthetic attributes to generate composite data, such that the composite data retains the statistical and analytical properties of the user data while obfuscating individual records to prevent identification.

The variable obfuscation subsystem may be configured to determine the appropriate level of data obfuscation based on trust factors associated with the entity that will receive the composite data. In this regard, the variable obfuscation subsystem may analyze various trust factors, such as the receiving entity's historical behavior, security certifications, regulatory compliance record, and the nature of its relationship with the data provider. Based on these factors, the variable obfuscation subsystem may determine the required level of obfuscation necessary to protect the individual user attributes. The variable obfuscation subsystem may then set a DTP, which dictates the level of detail or generalization in the synthetic attributes and/or the composite data. The variable obfuscation subsystem uses this DTP to trigger the generative AI subsystem to produce the composite data according to the specified transparency or opacity level, ensuring that the generated data aligns with the determined level of obfuscation.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer-or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the invention. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single in Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer-or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation-and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

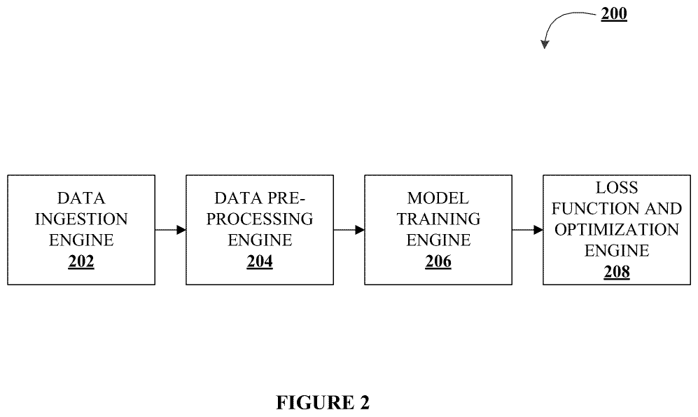

FIG. 2 illustrates an exemplary generative AI subsystem 200, in accordance with an embodiment of the invention. The generative AI subsystem 200 may include a data ingestion engine 202, a data pre-processing engine 204, a model training engine 206, and a loss function and optimization engine 208. It should be understood that the generative AI subsystem 200 is merely an example, and other embodiments may include more, fewer, or different components depending on the specific requirements and implementations of the system. For instance, additional engines for data validation, feature selection, or distributed computing may be integrated into the subsystem, or certain components described herein may be consolidated or omitted based on system performance objectives. Therefore, the generative AI subsystem 200 should not be considered limiting and may be adapted to various configurations within the scope of the invention.

The data ingestion engine 202 may identify various internal and/or external data sources to generate, test, and/or integrate new features for training the generative AI model. These internal and/or external data sources (e.g., text corpora, web-based text data, document repositories, or decentralized text storage system) may be initial locations where the data originates or where physical information is first digitized. In addition to conventional data sources, the data ingestion engine 202 may support decentralized storage systems, such as blockchain-based data sources, and privacy-preserving methods such as differential privacy. The data ingestion engine 202 may identify the location of the data and describe connection characteristics for access and retrieval of data. In some embodiments, data is transported from each data source using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, the these data sources may include Enterprise Resource Planning (ERP) databases that host data related to day-to-day business activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like.

Depending on the nature of the data, the data ingestion engine 202 may move the data to a destination for storage or further analysis. Typically, the data may be in varying formats as they come from different sources, including RDBMS, other types of databases, S3 buckets, CSVs, or from streams. For a large language model (“LLM”), text data may originate from sources such as web scrapes, social media, large public text datasets, or the like. Since the data comes from different places, it needs to be cleansed and transformed so that it can be analyzed together with data from other sources. The data may be ingested in real-time, using stream processing, in batches using a batch data warehouse, or a combination of both. Stream processing may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse collects and transfers data in batches according to scheduled intervals, trigger events, or any other logical ordering.

In machine learning, the quality of data and the useful information that can be derived therefrom directly affects the ability of the machine learning model to learn. The data pre-processing engine 204 may implement advanced integration and processing steps needed to prepare the data for machine learning execution, including tokenization, text normalization, and removal of irrelevant elements like HTML tags in web-based data, especially for LLM training. This may include modules to perform any upfront, data transformation to consolidate the data into alternate forms by changing the value, structure, or format of the data using generalization, normalization, attribute selection, and aggregation, text-specific transformations such as stemming and lemmatization, data cleaning by filling missing values, smoothing the noisy data, resolving the inconsistency, and removing outliers, and/or any other encoding steps as needed. In some embodiments, the data pre-processing engine 204 may perform real-time pre-processing at the edge via edge computing devices, allowing for the transformation and reduction of data prior to transmission to centralized locations, thereby reducing latency and conserving network bandwidth.

In addition to improving the quality of the data, the data pre-processing engine 204 may transform categorical data into numerical formats that are suitable for machine learning algorithms. In this regard, the data pre-processing engine 204 may use techniques such as one-hot encoding or label encoding depending on the nature of the categorical variables and the intended use of the data.

In some embodiments, the data pre-processing engine 204 may also include dimensionality reduction techniques, where the number of input features is reduced while retaining the most relevant information. In this regard, the data pre-processing engine 204 may include methods such as Principal Component Analysis (PCA) or apply feature selection algorithms to remove redundant or irrelevant features, thereby reducing the computational complexity of the model training phase. Feature selection may be particularly beneficial in datasets with a high number of features, ensuring that the generative AI models do not overfit to noise or irrelevant details. The pre-processed data output from the data pre-processing engine 204 may then be fed into the model training module 206.

The model training engine 206 may be responsible for training the generative AI models using the pre-processed data from the data pre-processing engine 204. The model training engine 206 may implement various machine learning algorithms, including but not limited to Generative Adversarial Networks (GANs), Variational Autoencoders (VAEs), transformers, diffusion models, or other specialized architectures depending on the specific requirements of the system. These models may be used in a broad range of applications, such as LLMs for text generation, image generation models, video synthesis models, audio generation models, and/or the like. The model training engine 206 may optimize these models by continuously adjusting their internal parameters based on the patterns and relationships identified within the data.

In some embodiments, the model training engine 206 may include a training data handler, which manages the partitioning of the pre-processed data into training, validation, and testing datasets. The training data is used to update the model's parameters, while the validation and testing datasets are reserved to evaluate the model's performance during and after training. The model training engine 206 may support various data-handling strategies, such as cross-validation or random shuffling, to ensure that the model generalizes well and is not overfitting to the training data.

In embodiments involving large language models, the model training engine 206 may utilize transformer-based architectures, such as the Transformer, BERT, GPT, or the like. Transformer models rely on mechanisms like self-attention to capture dependencies between words in a sequence, regardless of their distance from one another. The self-attention mechanism allows the model to weigh the importance of different words in a sentence and establish complex relationships important for understanding context. During training, the model may process vast amounts of text data and learn to predict the next word or token in a sequence based on the input context. This training process allows LLMs to generate coherent text, complete sentences, translate languages, or answer questions based on learned patterns from the data.

The transformer-based LLMs may be trained using autoregressive (e.g., GPT) or masked-language modeling techniques (e.g., BERT). In autoregressive models, the training process may include predicting the next word in a sequence by progressively revealing more context to the model. The model iteratively improves its predictions based on its performance during prior iterations. Masked-language modeling involves masking certain words in a sentence and training the model to correctly predict the masked words based on surrounding context. Both approaches enable LLMs to capture intricate patterns in human language, improving their ability to handle tasks such as summarization, translation, and text generation. Loss functions like cross-entropy loss may be used to optimize the model's performance by comparing predicted tokens with the actual tokens in the dataset to guide the model to minimize prediction errors during training.

In embodiments involving image generation models, the model training engine 206 may utilize transformer-based architectures, such as Vision Transformers (ViTs) or generative adversarial networks (GANs). Vision Transformers rely on self-attention mechanisms to process images as sequences of patches rather than whole images, allowing the model to capture spatial dependencies and patterns across the image. During training, the model may be exposed to large datasets containing diverse image types to learn features like textures, edges, and shapes. The model may then generate or reconstruct images by interpreting these patterns and applying learned spatial relationships. GAN-based models may also be used, where a generator network creates images, and a determinator network evaluates their realism, enabling the model to improve through adversarial training.

Image generation models may employ various training techniques, such as pixel-wise reconstruction or adversarial training, depending on the architecture. Pixel-wise reconstruction methods involve learning to reconstruct an image from its corrupted or downscaled version, optimizing the model to minimize the difference between the predicted and actual pixels (e.g., using mean squared error as the loss function). Adversarial training, often used with GANs, involves iteratively improving the generator network to produce images that are increasingly indistinguishable from real images, based on feedback from the determinator network. These approaches allow the model to capture complex visual features, enabling applications such as image synthesis, enhancement, and style transfer.

For video generation models, the model training engine 206 may employ transformer-based architectures like Video Transformers or GAN-based models specifically designed for handling temporal sequences. Video Transformers use self-attention mechanisms to model dependencies not only between pixels within a single frame but also across frames, allowing them to understand temporal relationships and motion patterns in videos. The model may be trained on large video datasets, enabling it to learn and reproduce dynamic changes and interactions between objects over time. GAN-based video models may incorporate spatiotemporal networks to evaluate the realism of generated video sequences, optimizing the model to produce continuous and coherent frames.

Video generation models may utilize spatial-temporal modeling techniques or adversarial training for generating realistic motion and video sequences. Spatial-temporal modeling involves learning the spatial features within each frame while simultaneously capturing the temporal dependencies between frames, optimizing the model's ability to predict future frames or complete missing sequences. Loss functions like mean squared error or perceptual loss may be applied to reduce discrepancies between predicted and actual frames. Adversarial training, on the other hand, may involve a generator creating video sequences and a determinator evaluating their realism, encouraging the generator to improve by minimizing the discrepancy identified by the determinator. These techniques may enable video generation models to create coherent and realistic sequences, useful in applications such as video synthesis and animation.

In audio generation models, the model training engine 206 may utilize architectures such as Audio Transformers or recurrent neural networks (RNNs) like WaveNet, designed to handle sequential and waveform data. Audio Transformers leverage attention mechanisms to capture relationships between segments of audio, allowing them to model temporal dependencies and predict the next audio sample based on previous context. During training, the model may process large audio datasets containing diverse sound patterns to learn representations of different audio features, such as frequency, amplitude, and harmonics. This training enables the model to generate coherent audio sequences, including speech, music, or ambient sounds, by synthesizing these learned patterns.

Audio generation models may be trained using sequence modeling techniques or autoregressive methods, depending on the architecture. Sequence modeling techniques involve processing and predicting sequences of audio samples, optimizing the model to capture and reproduce temporal dependencies in sound. Autoregressive methods, such as those employed in WaveNet, focus on predicting each audio sample based on prior samples, progressively refining the generated audio sequence over multiple iterations. Loss functions like mean absolute error or cross-entropy loss may be used to minimize the error between predicted and actual audio samples, guiding the model to improve its accuracy. These approaches allow audio generation models to create continuous and realistic audio outputs, applicable in areas such as speech synthesis, music generation, and sound effect creation.

The reconstruction loss ensures that the difference between the original input and the reconstructed output is minimized, guiding the decoder to generate outputs that closely resemble the input data. The second component, KL divergence loss, regularizes the latent space by ensuring that the distribution of latent variables conforms to a predefined probabilistic distribution, often a Gaussian distribution. This constraint encourages the model to learn a well-organized and smooth latent space, allowing for meaningful sampling from this space during inference. By combining these loss functions, the VAE can learn a latent space that not only captures the underlying patterns in the data but also allows for the generation of novel outputs by sampling new points from this space. During the inference phase, the trained model can sample random points from the latent space to generate new, previously unseen data instances.

In training generative AI models, the model training engine 206 may implement optimization techniques such as gradient clipping, learning rate scheduling, and mixed-precision training. Gradient clipping may be used to stabilize the training process, especially in transformer-based models, by capping the magnitude of gradients to prevent them from becoming excessively large. Learning rate scheduling may involve gradually increasing the learning rate during initial training phases (warm-up) and then decaying it as training progresses to fine-tune the model's parameters more effectively. Mixed-precision training, which leverages lower-precision (e.g., float16) arithmetic while retaining higher precision (e.g., float32) for specific calculations, may be used to accelerate training and reduce memory consumption, enabling the model to scale efficiently even when trained on large datasets.

In some embodiments, the model training engine 206 may implement early stopping mechanisms to prevent overfitting. Early stopping monitors the generative AI model's performance on the validation dataset, halting the training process if the performance does not improve after a specified number of iterations. This ensures that the generative AI model does not continue training on noise or irrelevant patterns, which could degrade its performance on unseen data. The model training engine 206 may also support distributed training across multiple computing nodes, allowing the system to scale its computational resources as needed. Distributed training may involve splitting the generative AI model and data across multiple machines or GPUs, where each node processes a portion of the data and updates the model in parallel. This is particularly useful for large datasets or models that require significant computational power, such as deep generative models. The model training engine 206 may synchronize the updates across the nodes using techniques like synchronous or asynchronous gradient descent.

Once the generative AI model is trained, the model training engine 206 may save the final trained generative AI model in a persistent storage location for future use. In specific embodiments, metadata such as the number of epochs, the final loss values, and values of learned parameters may be logged for model versioning and/or retraining at a later stage. In some embodiments, the model training engine 206 may also implement transfer learning, where a pre-trained model is fine-tuned on a smaller, domain-specific dataset. This may reduce the amount of time and data required to train a new model, especially in cases where the available data is limited or highly specialized. The model training engine 206 may adjust the parameters of the pre-trained model to better align with the new dataset, while preserving the learned features from the original training.

In embodiments involving LLMs, new output is generated by sampling from the model's probability distribution of tokens, conditioned on the context provided as input. Transformer-based architectures, such as GPT, use an auto-regressive approach where the model predicts the next token in a sequence one step at a time, using previously generated tokens as input for subsequent predictions. The process starts with a prompt or an initial sequence of words, and the model iteratively generates new tokens, forming coherent sentences or paragraphs based on the learned context and language patterns. For masked-language modeling (e.g., BERT), new output may be generated by filling in masked parts of the input sequence, allowing the model to complete sentences or generate variations of the provided text. The generated output can be controlled by adjusting parameters which may influence the randomness of the token sampling, enabling the generation of diverse or deterministic responses.

In image generation models, such as those using ViTs or GANs, new output is generated by sampling from the learned distribution in the model's latent space. For GANs, the generator network creates an image by transforming random noise vectors into structured image outputs through a series of layers that learn visual features like shapes, textures, and colors. The generated image is then refined through adversarial feedback from the determinator network, which assesses the realism of the generated output. For transformer-based image models, the process may involve reconstructing images by assembling patches based on the learned dependencies between them. Input conditions, such as prompts describing desired features or specific noise vectors, guide the generation process, allowing for the creation of customized images or variations of existing visual styles. These models may also generate images based on style transfer techniques or predefined templates; synthesizing images that align with the characteristics present in the training data.

Video generation models utilize spatiotemporal dependencies to synthesize new video sequences based on the patterns learned during training. In transformer-based architectures, the model may generate video frames sequentially, predicting the next frame based on the input frames and the temporal context established by prior frames. GAN-based models, specifically designed for video synthesis, may sample noise vectors or use a sequence of frames as input, transforming these into continuous and temporally coherent video outputs through the generator network. The determinator evaluates the temporal consistency and realism of the output, ensuring the generated video mimics the motion dynamics and object interactions present in real-world video data. Such models may also use attention mechanisms to focus on critical elements within each frame and their evolution across time, facilitating realistic scene transitions and motion patterns. The generation process may include user-defined input such as initial frames, motion descriptions, or specific video attributes, providing control over the output.

Audio generation models, including Audio Transformers or autoregressive architectures like WaveNet, generate new audio sequences by predicting audio samples based on learned dependencies in sequential sound data. For autoregressive models, the generation process involves producing each audio sample one at a time, conditioned on previously generated samples, allowing the model to build complex audio patterns such as speech, music, or ambient sounds. The model starts with an initial segment or a random seed and uses its learned parameters to predict and synthesize subsequent samples, constructing a continuous audio waveform. Audio Transformers, on the other hand, may use attention mechanisms to identify important temporal segments within the input audio and synthesize new output based on these learned patterns. The user can control the type of audio generated by providing parameters such as pitch, tempo, or initial sound clips, enabling the model to generate outputs tailored to specific use cases like speech synthesis, music composition, or environmental sound generation.

In some embodiments, generative AI models may also integrate multiple modalities, enabling cross-modal generation where output in one modality influences or conditions the generation in another. For example, a video generation model may use text descriptions as input, synthesizing video content that aligns with the specified narrative or visual scene described. Similarly, image generation models may generate visual representations based on audio inputs, such as generating animations synchronized to musical rhythms or speech patterns. These cross-modal systems typically involve conditional GANs or multi-modal transformers, where the model processes input from one domain (e.g., text or audio) and learns to generate output in another domain (e.g., video or image) by aligning the patterns and dependencies between the different modalities. These models may allow users to generate complex, multimodal content based on combinations of inputs, such as using textual prompts to control the visual and auditory elements of a video.

It will be understood that the embodiment of the generative AI subsystem 200 illustrated in FIG. 2 is exemplary and that other embodiments may vary. The generative AI subsystem 200, as well as its constituent elements, may vary, and modifications or alternative configurations may be implemented without departing from the broader scope of the invention. For instance, different machine learning algorithms, data sources, optimization techniques, or training methodologies may be employed depending on system requirements, application domain, and available computational resources. Furthermore, features and functionalities described in one embodiment may be combined with those of another embodiment as needed, and vice versa.

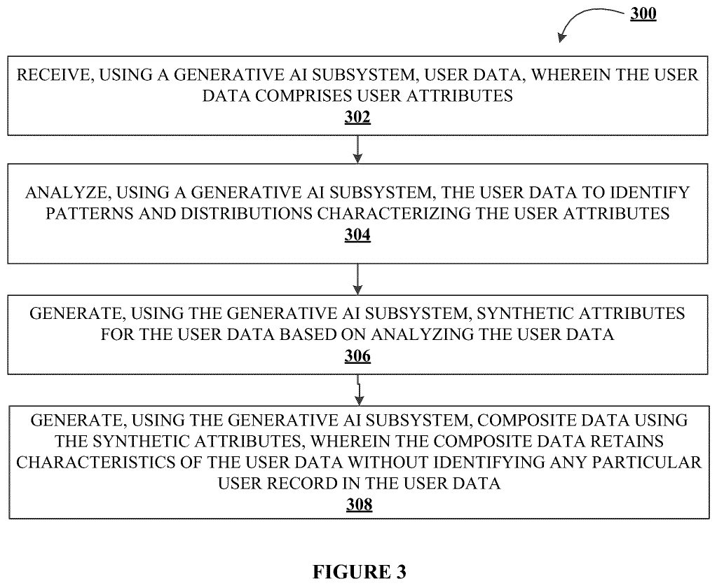

FIG. 3 illustrates a process flow 300 for generating composite data, in accordance with an embodiment of the invention. As shown in block 302, the process flow includes receiving, using a generative AI subsystem, user data, wherein the user data comprises user attributes. The user data may include user attributes, such as user group, behavioral, or transactional information. For example, the user attributes may include life stage, location, purchase history, browsing patterns, and other relevant characteristics that describe the user's actions or record. The generative AI subsystem may be configured to access this data from one or more data sources, such as databases, application programming interfaces (APIs), or user input forms.

As shown in block 304, the process flow includes analyzing, using a generative AI subsystem, the user data to identify patterns and distributions characterizing the user attributes. As described in FIG. 2, the generative AI subsystem may use machine learning models trained to detect correlations, trends, and statistical distributions within the data. The analysis may involve processing user group, behavioral, and transactional data points to uncover typical patterns and variations present across the user base. The generative AI subsystem may perform this analysis by examining various features and attributes individually and in combination, identifying how different attributes interact and vary. For example, the generative AI subsystem may identify correlations between life stage and purchase behavior or patterns linking location data with user preferences. The goal of this analysis is to understand the data's underlying structure, so that the system can replicate these structures without relying on any specific user record.

In some embodiments, the generative AI subsystem may use clustering techniques to group users with similar characteristics, thereby creating segments or clusters that reflect the diversity of the user base. This segmentation allows the generative AI subsystem to better generalize the patterns identified within each group, ensuring that synthetic attributes derived from these patterns are representative and not tied to individual users. Alternative embodiments may employ different types of AI models, such as recurrent neural networks (RNNs) or other deep learning architectures, particularly if the user data includes temporal or sequential elements (e.g., transaction histories over time). In some cases, the system may also integrate additional analytical techniques, such as regression analysis or dimensionality reduction, to simplify the data and highlight the most relevant patterns, optimizing the performance of the generative AI subsystem.

As shown in block 306, the process flow includes generating, using the generative AI subsystem, synthetic attributes for the user data based on analyzing the user data. In this regard, the generative AI subsystem may use the learned relationships and statistical characteristics to create synthetic versions of the user attributes. These synthetic attributes may be configured to closely resemble the original data patterns while ensuring that they do not correspond to any specific user record. The generative AI subsystem may be trained using the original user data so that they can replicate the underlying distributions found during the analysis phase. For example, if the analysis reveals a distribution of user life stages between 20 and 50, the generative AI subsystem may generate synthetic life stages that follow this distribution without reproducing any actual user's specific life stage.

In some embodiments, the generative AI subsystem may further fine-tune the synthetic attributes to maintain consistency with other related attributes, ensuring that the synthetic data aligns with realistic user behavior. For instance, if a synthetic attribute for a user's location is generated, the subsystem may adjust other related attributes (e.g., purchasing patterns) to be consistent with the location attribute, ensuring that the synthetic data retains the internal logic and dependencies observed in the original dataset.

Alternatively, the generative AI subsystem may generate synthetic attributes using a combination of data augmentation techniques, such as adding controlled variations or noise to the original user attributes. These variations ensure that the synthetic attributes are diverse and not linked to any single user while maintaining the statistical integrity needed for further processing. The generative AI subsystem may also employ cross-validation methods to ensure that the synthetic attributes meet predefined accuracy and variability criteria before being used to generate composite data.

As shown in block 308, the process flow includes generating, using the generative AI subsystem, composite data using the synthetic attributes, wherein the composite data retains characteristics of the user data without identifying any particular user record in the user data. The composite data may be generated to retain the overall characteristics and statistical properties of the original user data without tying it to any specific user record. In doing so, the system may ensure that the data remains useful for analysis and insight generation while protecting individual user anonymity. The generative AI subsystem may aggregate the synthetic attributes in various ways to create composite portfolios that represent groups or segments of users rather than individual users. For instance, the generative AI subsystem may blend synthetic attributes from multiple users within a cluster to produce a composite data portfolio that is statistically representative of the cluster but not traceable to any one user. Such an aggregation approach may maintain the integrity of user group distributions, behavioral patterns, and other key attributes necessary for analysis.

In some embodiments, the generative AI subsystem may adjust the composition of the synthetic data based on the identified clusters or segments to ensure that the composite data reflects the diversity and variation within the user population. For example, if the user data comprises different life stage groups with distinct behaviors, the subsystem may generate multiple composite portfolios to accurately represent these variations, preserving the utility of the data for analytical purposes. Alternatively, the generative AI subsystem may generate composite data by combining synthetic attributes with additional noise or random variations to further obscure individualized information. The noise may be applied in a controlled manner to retain the underlying patterns while enhancing privacy. The generative AI subsystem may also validate the composite data against the original user data patterns to confirm that it adequately mirrors the distribution and variability of the original dataset without duplicating any specific records.

The composite data, once generated, may be stored for further processing or analysis, or it may be used directly for data sharing with third parties, ensuring that it complies with privacy and data protection standards while providing valuable insights into user behaviors and trends.

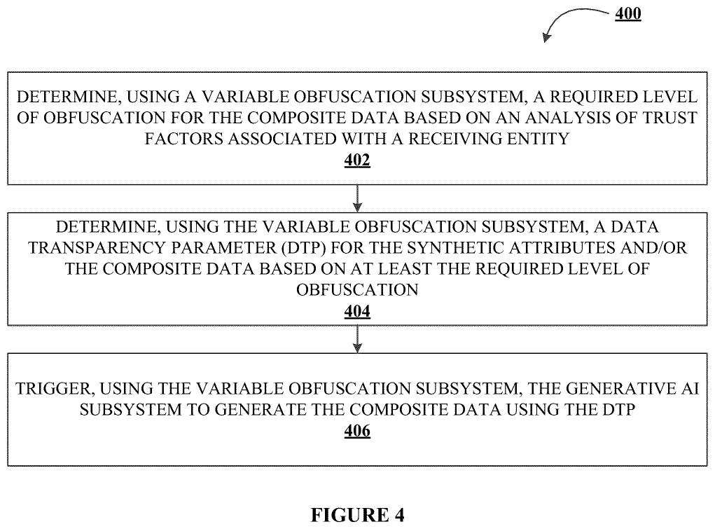

FIG. 4 illustrates a process flow 400 for generating composite data based on a data transparency parameter, in accordance with an embodiment of the invention. As shown in block 402, the process flow includes determining, using a variable obfuscation subsystem, a required level of obfuscation for the composite data based on an analysis of trust factors associated with a receiving entity. The variable obfuscation subsystem may evaluate several trust factors, such as the receiving entity's historical data handling practice, security certifications and compliance history, duration and nature of business relationship with the receiving entity, data sensitivity assessment, internal security infrastructure, third-party assessments, organizational maturity and information technology (IT) capability, data usage policies and agreements, geographical jurisdiction, or reputation and market standing. The analysis may involve scoring or categorizing the receiving entity based on these factors to assess the level of exposure associated with data sharing.

Based on this assessment, the variable obfuscation subsystem may establish the level of obfuscation necessary to adequately protect individual user information while retaining the utility of the data for the intended analysis. In some embodiments, the variable obfuscation subsystem may implement a predefined scale or threshold system where the receiving entity's trust level dictates the extent of data obfuscation required. For instance, a higher trust score may correspond to a lower level of obfuscation, while a lower trust score may trigger a higher level of obfuscation.

Alternatively, the variable obfuscation subsystem may incorporate a dynamic evaluation mechanism that continuously updates the trust level of the receiving entity based on new data or changes in the entity's behavior. In such configurations, the required level of obfuscation may be adjusted in real-time to accommodate shifts in trustworthiness, ensuring that the data protection measures are responsive to the most current information available, allowing the system to maintain a balance between data utility and privacy protection as the nature of the relationship evolves.

As shown in block 404, the process flow includes determining, using the variable obfuscation subsystem, a data transparency parameter (DTP) for the synthetic attributes and/or the composite data based on at least the required level of obfuscation. The DTP may serve as a configurable control, allowing the system to set the degree of detail or opacity embedded in the composite data. The variable obfuscation subsystem may use the required obfuscation level, which was previously determined based on the trust factors of the receiving entity, as a basis for setting the DTP.

The DTP may be scaled along a continuum ranging from fully transparent to fully opaque, with various intermediate levels for fine-tuning the detail level. For example, if the receiving entity has a high trust score or a well-established relationship with the data provider, the DTP may be set to a low value. This configuration allows the generative AI subsystem to produce composite data that retains a higher degree of the original information's transparency, providing detailed insights such as granular user group data or behavioral patterns while still anonymizing individual user records. In contrast, when the trust factors indicate a moderate level of trust, the subsystem may adjust the DTP to an intermediate value. This setting ensures that the synthetic attributes retain the essential characteristics needed for analysis but that specific details are generalized or transformed to prevent potential re-identification. For instance, exact numerical values like a user's life stage may be converted into broader ranges, or specific geographic information may be aggregated into larger regional categories. If the receiving entity is deemed less trustworthy—such as a new vendor or a third-party service with limited data security history—the DTP may be set to a high value. This setting prompts the generative AI subsystem to generate highly opaque composite data that contains only broad statistical summaries or heavily aggregated patterns, significantly minimizing the exposure of individual user identification. In some embodiments, the DTP determination process may involve dynamically adjusting the parameter as the trust factors are updated, such that variable obfuscation subsystem to maintain a real-time response to changes in the receiving entity's behavior or the sensitivity level of the data being shared.

As shown in block 406, the process flow includes triggering, using the variable obfuscation subsystem, the generative AI subsystem to generate the composite data using the DTP. Based on the DTP, the generative AI subsystem adjusts the synthetic attributes and the composition of the data to match the required level of transparency or opacity. If the DTP is set to a low value, indicating a high level of trust with the receiving entity, the generative AI subsystem may generate composite data that includes detailed and granular information, such as specific user group patterns or precise behavioral trends, while ensuring that no individual user can be directly identified. This configuration retains the utility of the data for in-depth analysis or insights. For an intermediate DTP value, the generative AI subsystem may adjust the synthetic attributes to blur sensitive details, generating composite data that maintains key features of the user data necessary for analysis but generalizes information to reduce the exposure of re-identification. For example, individual life stages may be expanded into broader ranges, and precise location data may be grouped into larger areas, ensuring that the data remains valuable while protecting user anonymity. If the DTP indicates a high level of obfuscation, the generative AI subsystem produces highly aggregated and generalized composite data. This output may consist of broad statistical insights or summaries that minimize individualized information. Such a configuration significantly reduces the possibility of linking the composite data back to any single user record, ensuring the highest level of privacy protection, especially for entities with lower trust scores.

In some embodiments, the variable obfuscation subsystem may continuously monitor the generative AI subsystem's output to verify that the composite data generated aligns with the DTP settings. If discrepancies or deviations from the specified obfuscation level are detected, the variable obfuscation subsystem may reconfigure the generative AI subsystem to adjust the output accordingly.

Embodiments of the present disclosure are described below with reference to block diagrams and flowchart illustrations. Thus, it should be understood that each block of the block diagrams and flowchart illustrations may be implemented in the form of a computer program product; an entirely hardware embodiment; an entirely firmware embodiment; a combination of hardware, computer program products, and/or firmware; and/or apparatuses, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically configured machines performing the steps or operations specified in the block diagrams and flowchart illustrations. Accordingly, the block diagrams and flowchart illustrations support various combinations of embodiments for performing the specified instructions, operations, or steps.

Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the methods described above may include fewer steps in some cases, while in other cases the methods may include additional steps. The steps of the methods and modifications to the steps of the methods described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for generating composite data, the system comprising:
a generative Artificial Intelligence (AI) subsystem, configured to:
receive user data, wherein the user data comprises user attributes;
analyze the user data to identify patterns and distributions characterizing the user attributes;
generate synthetic attributes for the user data based on analyzing the user data; and
generate composite data using the synthetic attributes, wherein the composite data retains characteristics of the user data without identifying any particular user record in the user data;
a variable obfuscation subsystem operatively coupled to the generative AI subsystem, configured to:
determine a required level of obfuscation for the composite data based on an analysis of trust factors associated with a receiving entity;
determine a data transparency parameter (DTP) for the synthetic attributes and/or the composite data based on at least the required level of obfuscation; and
trigger the generative AI subsystem to generate the composite data using the DTP.

2. The system of claim 1, wherein the user attributes comprise at least one of user group data, behavioral data, or transactional data.

3. The system of claim 1, wherein the generative AI subsystem is further configured to:
generate the synthetic attributes for the user data that mirror the identified patterns and distributions.

4. The system of claim 1, wherein the generative AI subsystem is further configured to:
dynamically update the synthetic attributes as new user data is received, such that the generated composite data reflects the most recent patterns and distributions in the user data.

5. The system of claim 1, wherein the trust factors associated with the receiving entity comprises at least one of a historical data handling practice, security certifications and compliance history, duration and nature of business relationship with the receiving entity, data sensitivity assessment, internal security infrastructure, third-party assessments, organizational maturity and information technology (IT) capability, data usage policies and agreements, geographical jurisdiction, or reputation and market standing.

6. The system of claim 1, wherein the DTP ranges between a fully transparent level and a fully opaque level, allowing for fine-tuning of user record detail embedded in the composite data.

7. The system of claim 1, wherein the generative AI subsystem, when triggered with a low DTP value by the variable obfuscation subsystem, generates composite data that retains more detailed information for analysis while anonymizing specific user records.

8. The system of claim 1, wherein the generative AI subsystem, when triggered with an intermediate DTP value, generalizes the synthetic attributes such that specific user information, such as precise life stages or locations, is transformed into broader categories or ranges.

9. The system of claim 1, wherein the generative AI subsystem, when triggered with a high DTP value, generates highly aggregated and generalized composite data, retaining only broad statistical insights to minimize exposure of re-identification of individual user records.

10. The system of claim 1, wherein the variable obfuscation subsystem is further configured to:
dynamically adjust the DTP in real-time based on updates in the receiving entity's trust status or changes in sensitivity of the user data.

11. A computer program product for generating composite data, the computer program product comprising a non-transitory computer-readable medium comprising code configured to cause an apparatus to:
receive user data, wherein the user data comprises user attributes;
analyze the user data to identify patterns and distributions characterizing the user attributes;
generate synthetic attributes for the user data based on analyzing the user data;
generating composite data using the synthetic attributes, wherein the composite data retains characteristics of the user data without identifying any particular user record in the user data;
determine a required level of obfuscation for the composite data based on an analysis of trust factors associated with a receiving entity;
determine a data transparency parameter (DTP) for the synthetic attributes and/or the composite data based on at least the required level of obfuscation; and
trigger the generative AI module to generate the composite data using the DTP.

12. The computer program product of claim 11, wherein the user attributes comprise at least one of user group data, behavioral data, or transactional data.

13. The computer program product of claim 11, wherein the code further causes the apparatus to:
generate the synthetic attributes for the user data that mirror the identified patterns and distributions.

14. The computer program product of claim 11, wherein the code further causes the apparatus to:
dynamically update the synthetic attributes as new user data is received, such that the generated composite data reflects the most recent patterns and distributions in the user data.

15. The computer program product of claim 11, wherein the trust factors associated with the receiving entity comprises at least one of a historical data handling practice, security certifications and compliance history, duration and nature of business relationship with the receiving entity, data sensitivity assessment, internal security infrastructure, third-party assessments, organizational maturity and information technology (IT) capability, data usage policies and agreements, geographical jurisdiction, or reputation and market standing.

16. The computer program product of claim 11, wherein the DTP ranges between a fully transparent level and a fully opaque level, allowing for fine-tuning of detail embedded in the composite data.

17. The computer program product of claim 11, wherein the code further causes the apparatus to:
dynamically adjust the DTP in real-time based on updates in the receiving entity's trust status or changes in sensitivity of the user data.

18. A method for generating composite data, the method comprising:
receiving, using a generative AI subsystem, user data, wherein the user data comprises user attributes;
analyzing, using a generative AI subsystem, the user data to identify patterns and distributions characterizing the user attributes;
generating, using the generative AI subsystem, synthetic attributes for the user data based on analyzing the user data;
generating, using the generative AI subsystem, composite data using the synthetic attributes, wherein the composite data retains characteristics of the user data without identifying any particular user record in the user data;
determining, using a variable obfuscation subsystem, a required level of obfuscation for the composite data based on an analysis of trust factors associated with a receiving entity;
determining, using the variable obfuscation subsystem, a data transparency parameter (DTP) for the synthetic attributes and/or the composite data based on at least the required level of obfuscation; and
triggering, using the variable obfuscation subsystem, the generative AI subsystem to generate the composite data using the DTP.

19. The method of claim 18, wherein the user attributes comprise at least one of user group data, behavioral data, or transactional data.

20. The method of claim 18, wherein the method further comprises:
generating the synthetic attributes for the user data that mirror the identified patterns and distributions.
